(19) United States
(12) Patent Application Publication
(10) Pub. No.: US 2017/0083858 A1
(43) Pub. Date: Mar. 23, 2017

(54) DISPLAY, MANAGEMENT SYSTEM, AND NON-TRANSITORY COMPUTER READABLE MEDIUM

(71) Applicant: FUJI XEROX CO., LTD., Tokyo (JP)

(72) Inventor: Hayato YOSHIKAWA, Kanagawa (JP)

(73) Assignee: FUJI XEROX CO., LTD., Tokyo (JP)

(21) Appl. No.: 14/986,798

(22) Filed: Jan. 4, 2016

(30) Foreign Application Priority Data
Sep. 18, 2015 (JP) 2015-184953

(51) Int. Cl. G06Q 10/08

(52) U.S. Cl. CPC G06Q 10/0833

(57) ABSTRACT

A display displays management information regarding a product that is shipped from a consignor to a first consignee and is further shipped from the first consignee to a second consignee. The display has different display modes each of which is used for displaying a corresponding one of the management information for the first consignee and the management information for the second consignee.

### CROSS-REFERENCE TO RELATED APPLICATIONS

This application is based on and claims priority under 35 USC 119 from Japanese Patent Application No. 2015-184953 filed Sep. 18, 2015.

### BACKGROUND

### Technical Field

The present invention relates to a display, a management system, and a non-transitory computer readable medium.

### SUMMARY

According to an aspect of the invention, there is provided a display that displays management information regarding a product that is shipped from a consignor to a first consignee and is further shipped from the first consignee to a second consignee. The display has different display modes each of which is used for displaying a corresponding one of the management information for the first consignee and the management information for the second consignee.

### BRIEF DESCRIPTION OF THE DRAWINGS

An exemplary embodiment of the present invention will be described in detail based on the following figures, wherein:

FIG. 1 is a system configuration diagram illustrating a management system according to an exemplary embodiment of the invention;

FIG. 2 is a block diagram illustrating the configuration of a system block corresponding to a consignor in the management system according to the exemplary embodiment of the invention;

FIG. 3 is a block diagram illustrating the hardware configuration of a terminal apparatus according to the exemplary embodiment of the invention;

FIG. 4 is a schematic diagram illustrating the flow of products and corresponding flow of information in the exemplary embodiment of the invention;

FIG. 5 is a plan diagram illustrating an example of displaying performed by the terminal apparatus according to the exemplary embodiment of the invention;

FIG. 6 is a flowchart illustrating a reception process performed by the terminal apparatus according to the exemplary embodiment of the invention;

FIG. 7 is a flowchart illustrating a management information generation process performed by a server apparatus according to the exemplary embodiment of the invention;

FIG. 8 is a diagram illustrating a screen for displaying management information on a display, of a consignor, according to the exemplary embodiment of the invention;

FIG. 9 is a schematic diagram illustrating information flow in a case of occurrence of a malfunction in the exemplary embodiment of the invention; and

FIG. 10 is a diagram illustrating a screen for displaying management information on the display, of a first consignee, according to the exemplary embodiment of the invention.

### DETAILED DESCRIPTION

An exemplary embodiment of the invention will next be described in detail with reference to the drawings.

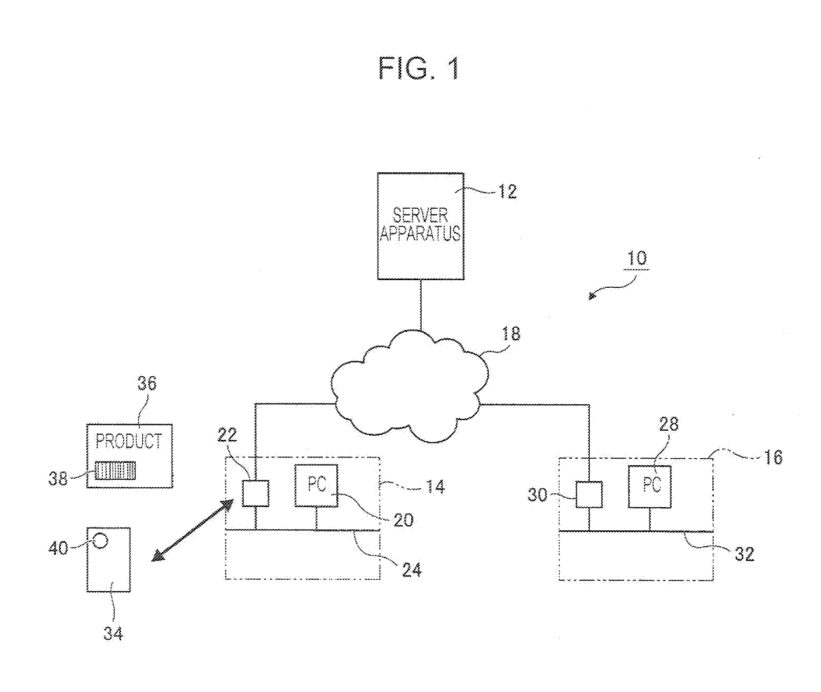

FIG. 1 illustrates a management system 10 according to the exemplary embodiment of the invention.

The management system 10 includes a server apparatus 12 of a consignor (for example, a manufacturer). The server apparatus 12 of the consignor is connected to a local network 14 of a first consignee (for example, a first dealer A) and a local network 16 of a second consignee (for example, a second dealer B) through, for example, the Internet 18.

The term “consignor” denotes a natural person or a corporate body that ships a product to a natural person or a corporate body. The term “consignee” used for the first and second consignees denotes a natural person or a corporate body that receives a product from a natural person or a corporate body and that ships the product to another natural person or another corporate body.

The local network 14 of the first dealer A includes, for example, a personal computer (PC) 20 and an access point 22 that are connected to each other through an intranet 24. The local network 16 of the second dealer B also includes, for example, a PC 28 and an access point 30 that are connected to each other through an intranet 32 in the same manner.

A terminal apparatus 34 is, for example, a smartphone. A camera 40 provided to the terminal apparatus 34 reads a code 38 such as a barcode provided on a package of a product 36 such as a printer, and data thus read is transmitted to the server apparatus 12.

Note that the consignor and the second consignee also have terminal apparatuses 34.

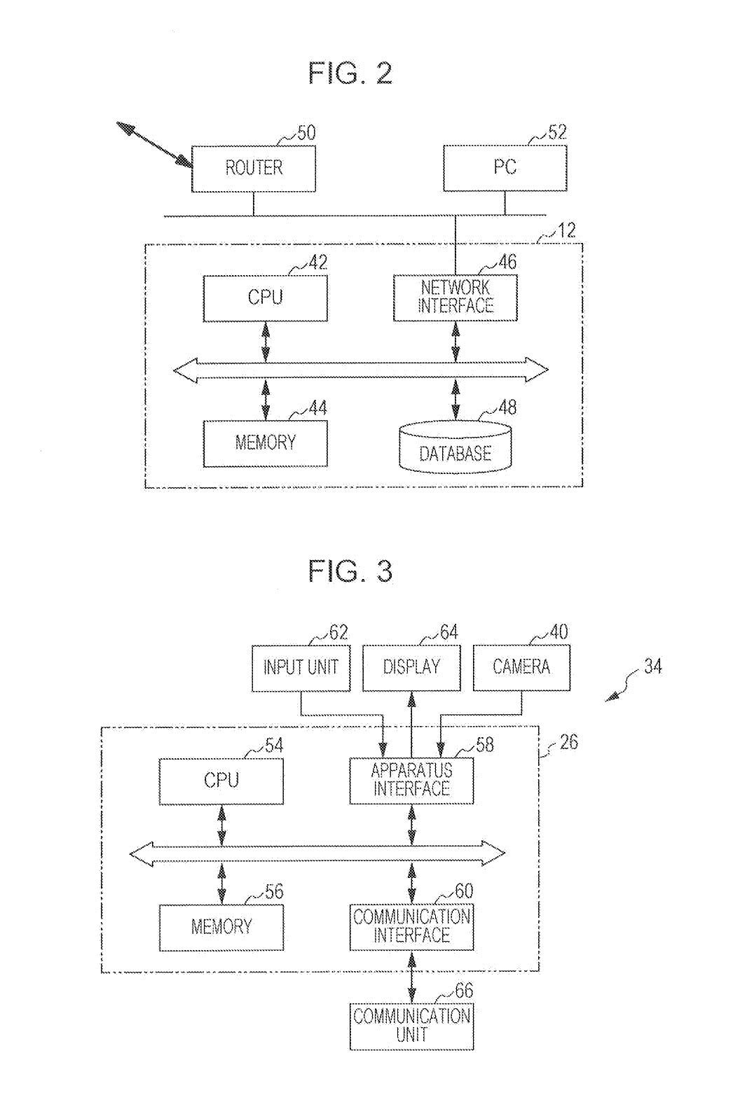

FIG. 2 illustrates the configuration of a system block corresponding to the manufacturer in the management system 10 including the server apparatus 12.

The server apparatus 12 includes a CPU 42, a memory 44, a network interface 46, and a database 48 that are mutually connected through a bus or the like. The CPU 42 controls the server apparatus 12 in accordance with a program stored in the memory 44. The CPU 42 is connected to a PC 52 and a router 50 for connecting to the Internet 18 through the network interface 46. The database 48 stores management information regarding product distribution. The management information includes the name of a product, the serial number of the product, the place of the product, the current state of the product, a customer as a destination, malfunction information, and the like.

FIG. 3 illustrates the hardware configuration of the terminal apparatus 34.

The terminal apparatus 34 includes a controller 26. The controller 26 includes a CPU 54, a memory 56, an apparatus interface 58, and a communication interface 60 that are mutually connected through a bus or the like. The CPU 54 controls the terminal apparatus 34 in accordance with a program stored in the memory 56. An input unit 62 such as a touch panel, a display 64 such as a liquid crystal display, and the camera 40 described above are connected to the apparatus interface 58. A communication unit 66 is connected to the communication interface 60. Data read by the camera 40 is temporarily loaded into the memory 56 and then transmitted to the outside through the communication unit 66.

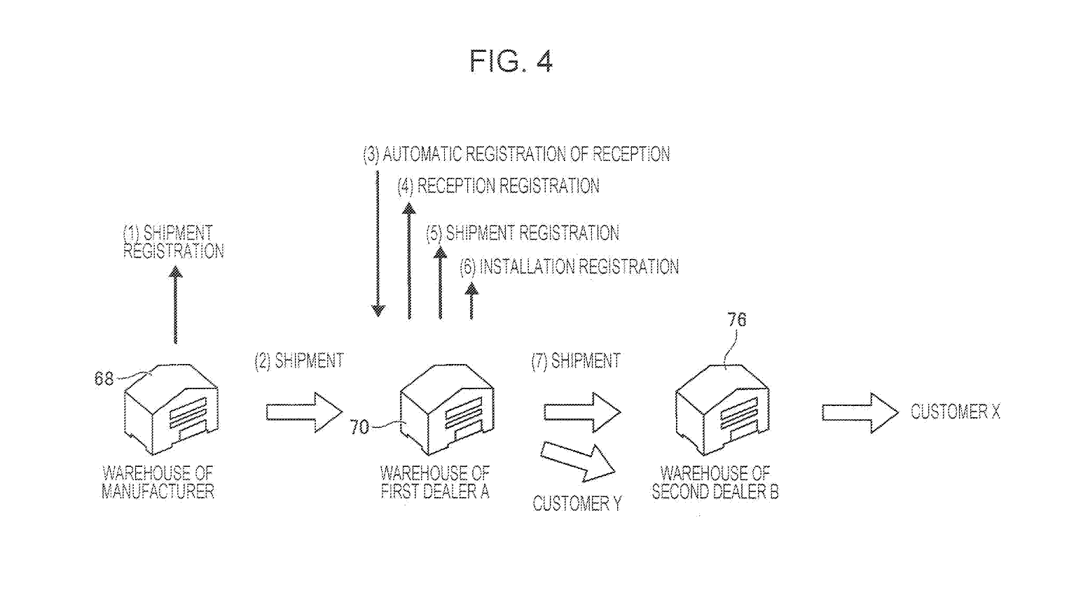

FIG. 4 illustrates the flow of a product and corresponding flow of information.

The manufacturer assigns serial numbers to products, respectively, at the time of manufacturing. Each serial number is provided on the package of the product by using code information such as a barcode indicating the serial number. When a product is shipped from a warehouse 68 of the manufacture, as described in (1), information indicating shipment is input in such a manner that the terminal apparatus 34 reads the barcode of the product and is further output to the server apparatus 12 through the Internet 18, and the state of the product is registered as “shipped” in the server apparatus 12. The product is shipped from the warehouse 68 of the manufacturer to the first dealer A as described in (2).

At the first dealer A, as described in (3), the state of the product is automatically registered as “incoming” in a case where the state of the product has been registered as “shipped” by the manufacturer. Specifically, data registered as “shipped” in the server apparatus 12 of the manufacturer is automatically converted into data indicating “incoming” at the first dealer A. The data is displayed as “incoming” at the first dealer A, and the manufacturer and the first dealer A each have corresponding display content depending on the state.

The first dealer A performs registration indicating that the product has been received. At the time of the registration, an inspection is performed on the received product in such a manner that the terminal apparatus 34 reads the barcode of the product. The inspected product is received at a warehouse 70 of the first dealer A.

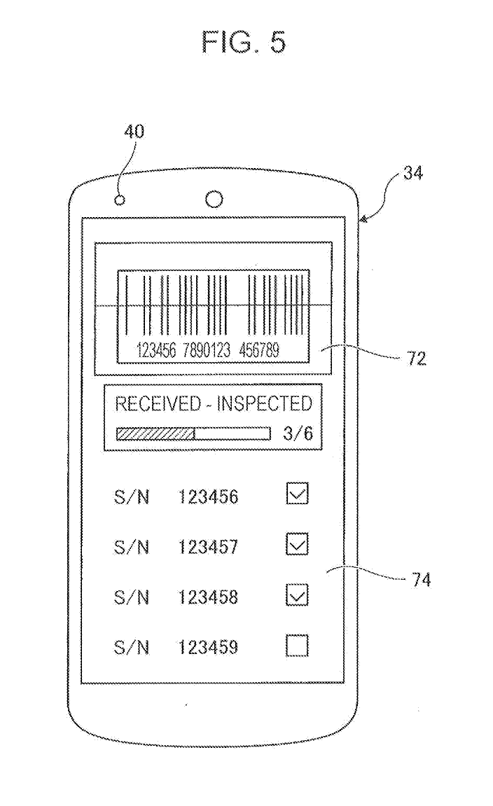

Specifically, as illustrated in FIG. 5, the terminal apparatus 34 includes a first display 72 that displays the barcode of a product captured by the camera 40 and a second display 74 that displays information regarding an incoming product. The barcode displayed in the first display 72 is transmitted to the server apparatus 12. The second display 74 displays serial numbers on a per group basis and is provided with checkboxes for the respective serial numbers. The screen in FIG. 5 indicates that six products belong to a specific group, six serial numbers are assigned to the respective products, and three of the six products assigned the serial numbers have been inspected.

Note that the second display 74 displays up to four serial numbers due to a limited display area. The remaining two serial numbers are hidden in the second display 74 but appear in the second display 74, for example, when the list is scrolled.

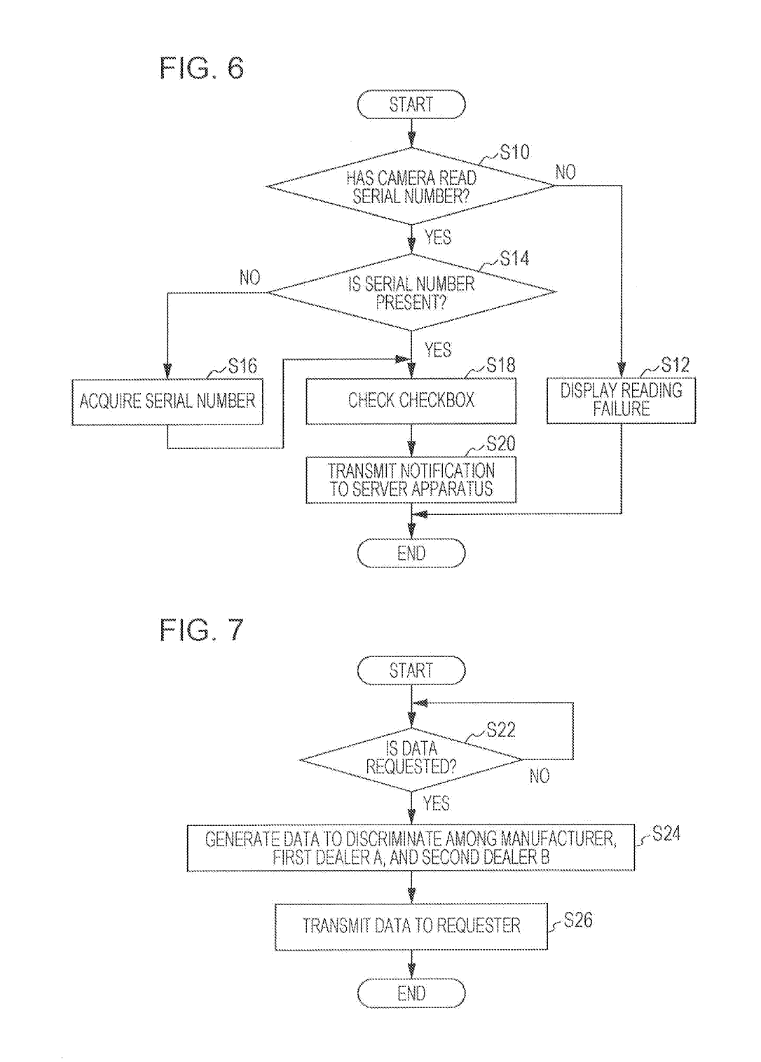

Further, operation of the terminal apparatus 34 will be described. As illustrated in FIG. 6, first in step S10, it is determined whether the camera 40 has successfully read the serial number of a product. If the serial number has not been read, the process proceeds to step S12, and the terminal apparatus 34 indicates that the serial number has not been read successfully. The process is subsequently terminated. In contrast, if the serial number has been read successfully in step S10, the process proceeds to step S14. In step S14, it is determined whether the serial number is present in transmitted data regarding a group of products. If it is determined that the serial number is not present (for example, in a case where a product assigned the serial number has not been scheduled to be shipped from the manufacturer but actually has been shipped), the process proceeds to step S16, and the terminal apparatus 34 acquires the serial number from the server apparatus 12. If it is determined in step S14 that the serial number is present, or after step S16 is completed, the process proceeds to step S18, and the corresponding checkbox is checked. In step S20, the terminal apparatus 34 transmits, to the server apparatus 12, a notification indicating that the reception process has been completed. The process is subsequently terminated.

Referring back to FIG. 4, at the first dealer A, the serial number of the received product is transmitted to the server apparatus 12, the state of the product is registered as, for example, “warehoused”, and the product is received at the warehouse 70 of the first dealer A.

The first dealer A ships the product to the second dealer B or a customer Y, depending on the case. In a case where the product is shipped to the second dealer B, as described in (5), information indicating shipment to the second dealer B is input in such a manner that the terminal apparatus 34 reads the barcode of the product and is further output to the server apparatus 12 through the Internet 18, and the state of the product is registered as “shipped to Company B” in the server apparatus 12. The product is shipped from the warehouse 70 of the first dealer A to the second dealer B as described in (7).

In contrast, in a case where the product is shipped from the first dealer A to the customer Y, as described in (6), installation information is registered as an installation report after installation of the product. The installation information includes the name of the product installed, the serial number, the customer name, the installation year and date, and information regarding difficulty at the time of installation.

Note that the flow of a product is not limited to the case described above. For example, the second dealer B receives products of the same item from the first dealer A and another first dealer in some cases. In addition, for example, in a case where the second dealer B refuses to disclose the management information to the first dealer A, the first dealer A is not allowed to access the management information for the second dealer B.

FIG. 7 illustrates operation of the server apparatus 12 performed in a case where the manufacturer, the first dealer A, and the second dealer B request the server apparatus 12 for access to the management information.

In step S22, the server apparatus 12 stands by until any of the manufacturer, the first dealer A, and the second dealer B requests data regarding the management information. If it is determined in step S22 that data has been requested, the process proceeds to step S24, and the server apparatus 12 acquires the management information from the database 48 and generates data in such a manner as to discriminate among the manufacturer, the first dealer A, and the second dealer B. In step S26, the server apparatus 12 transmits the discriminable data generated in step S24 to the one of the manufacturer, the first dealer A, and the second dealer B who requests the data.

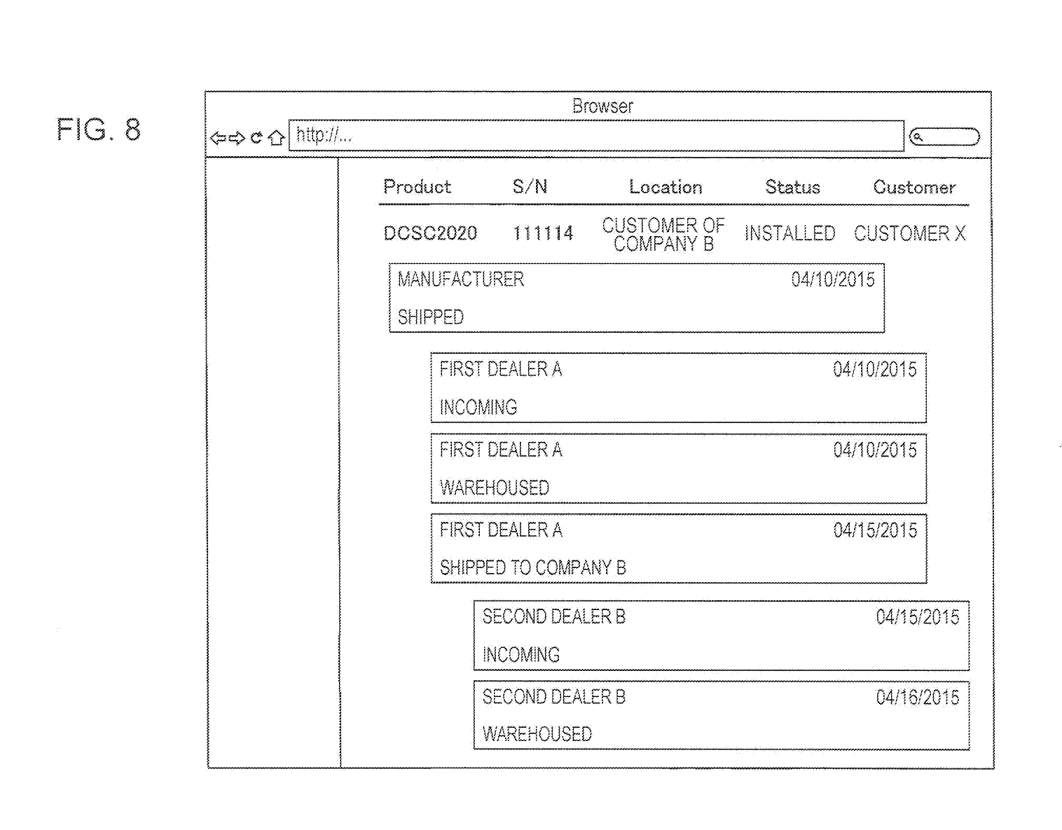

FIG. 8 illustrates a screen included in a display 52a of the PC 52 of the manufacturer.

As illustrated in FIG. 8, the display 52a displays a list of pieces of management information regarding a product having a serial number of 111114 in such a manner that the pieces of management information are viewable as a timeline. Specifically, the product having the serial number of 111114 is shipped from the manufacturer on Apr. 10, 2015 (“incoming” at the first dealer A), warehoused at the first dealer A on Apr. 10, 2015, shipped from the first dealer A to the second dealer B on Apr. 15, 2015 (“incoming” at the second dealer B), and further warehoused at the second dealer B on Apr. 16, 2015. Thereafter, the product is installed at the site of a customer X of the second dealer B. The management information ranging from shipment from the second dealer B to the installation at the customer X is hidden below the warehousing information for the second dealer B and appears when the list is scrolled.

The pieces of management information are displayed in such a manner as to be indented differently for the manufacturer, the first dealer A, and the second dealer B. Specifically, three pieces of management information for the first dealer A are indented from the piece of management information for the manufacturer, and two pieces of management information for the second dealer B are indented from the three piece of management information for the first dealer A. As long as the pieces of management information are discriminated between the first dealer A and the second dealer B, any display mode may be used. For example, the pieces of management information may be provided with different marks, may be framed or filled with different colors, and may be provided to have different font colors, font sizes, font types, boldfaces, and the like.

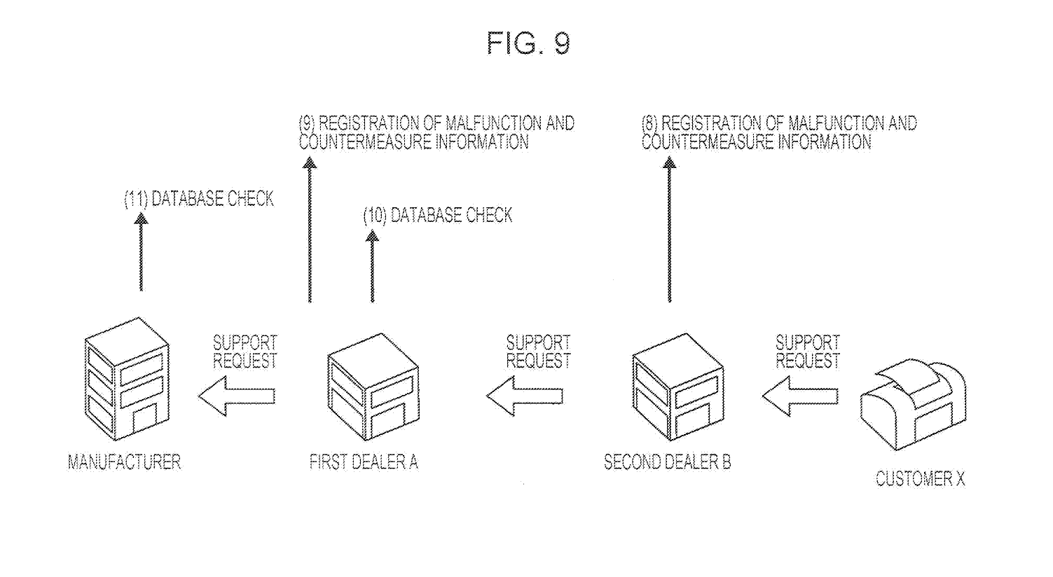

FIG. 9 illustrates information flow in a case of a malfunction at the customer X.

As illustrated in FIG. 9, when a product at the customer X malfunctions, the customer X makes a support request to the second dealer B. As described in (8), the second dealer B requested for support registers malfunction information and countermeasure information in the server apparatus 12. If the second dealer B fails to find a solution to the malfunction, the second dealer B makes a support request to the first dealer A. As described in (9), the first dealer A requested for support registers malfunction information and countermeasure information in the server apparatus 12 and as described in (10), checks data registered in the database. If the first dealer A fails to find a solution to the malfunction, the first dealer A makes a support request to the manufacturer. As described in (11), the manufacturer requested for support checks the database and copes with the malfunction to find a solution to the malfunction.

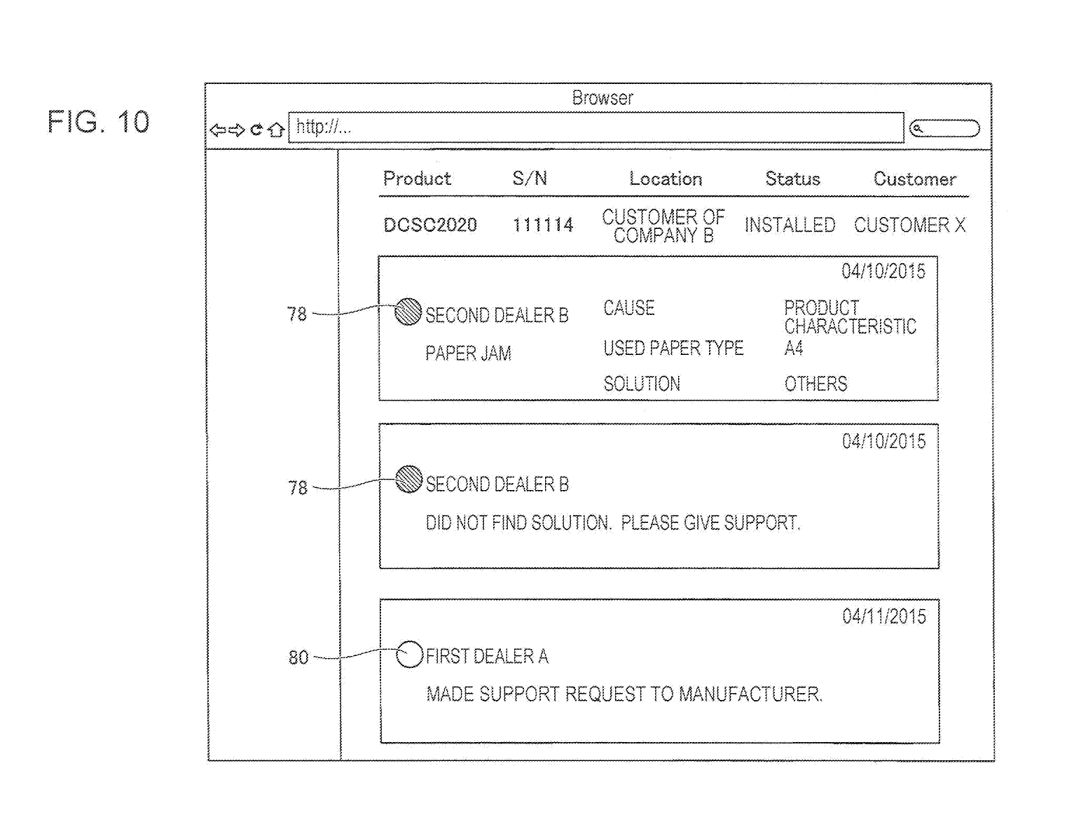

FIG. 10 illustrates a screen included in a display 20a of the PC 20 of the first dealer A.

As illustrated in FIG. 10, the display 20a displays pieces of management information regarding the product having the serial number of 111114 in such a manner that the pieces of management information are viewable as a timeline. Specifically, the display 20a indicates, on its screen, that the product having the serial number of 111114 at the second dealer B has a malfunction such as a paper jam on Apr. 10, 2015, the causes and the like of the malfunction are registered as a report in the server apparatus 12 on Apr. 10, 2015, the second dealer B fails to find a solution to the malfunction and makes a support request to the first dealer A on Apr. 10, 2015, and the first dealer A makes a support request to the manufacturer on Apr. 11, 2015. The malfunction information and the countermeasure information registered by the second dealer B are associated with each other.

Note that each piece of management information for the first dealer A and each piece of management information for the second dealer B are provided with marks 78 and 80, respectively, so as to be discriminated from each other. As long as the pieces of the management information for the first dealer A and the second dealer B are discriminated from each other, any display mode may be used. The display mode is not limited to the providing of marks. For example, the pieces of management information may be paragraphed, may be framed or filled with different colors, and may be provided to have different font colors, font sizes, font types, boldfaces, and the like.

Note that the server apparatus 12 of the manufacturer manages the management information regarding products in the description of the exemplary embodiment, but the exemplary embodiment of the invention is not limited thereto. Any management apparatus connected through a network such as the Internet may be used. In addition, the display is not limited to a PC and may be a terminal apparatus such as a smartphone.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display that displays management information regarding a product that is shipped from a consignor to a first consignee and is further shipped from the first consignee to a second consignee,
the display having different display modes each of which is used for displaying a corresponding one of the management information for the first consignee and the management information for the second consignee.

2. The display according to claim 1,
wherein a plurality of pieces of at least one of the management information for the first consignee and the management information for the second consignee are displayed as a list so as to be viewable as a timeline.

3. The display according to claim 1,
wherein the management information includes malfunction information and countermeasure information, and the display displays the malfunction information and the countermeasure information in association with each other.

4. The display according to claim 2,
wherein the management information includes malfunction information and countermeasure information, and the display displays the malfunction information and the countermeasure information in association with each other.

5. A management system comprising:
a management apparatus that manages management information regarding a product that is shipped from a consignor to a first consignee and is further shipped from the first consignee to a second consignee;
a display that displays the management information managed by the management apparatus; and
a controller that performs control to display the management information for the first consignee and the management information for the second consignee in different display modes on the display.

6. A non-transitory computer readable medium storing a program causing a computer to execute a process comprising:
managing management information regarding a product that is shipped from a consignor to a first consignee and is further shipped from the first consignee to a second consignee; and
performing control to display the management information for the first consignee and the management information for the second consignee in different display modes.
